(19) United States
(12) Patent Application Publication
(10) Pub. No.: US 2009/0274510 A1
(43) Pub. Date: Nov. 5, 2009

(54) System for tightly covering a supporting element in the area of a recess

(76) Inventors: Edith Basserie, Voreppe (FR); Didier Fraysse, Savigny sur Orge (FR)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 11/666,478

(22) PCT Filed: Oct. 27, 2005
(86) PCT No.: PCT/EP2005/011507

§ 371 Date: Feb. 10, 2009

(30) Foreign Application Priority Data
Nov. 26, 2004 (DE) 10 2004 057 163.5

(51) Int. Cl. F16J 13/00

(52) U.S. Cl. 403/23

(57) ABSTRACT

The invention relates to a system for tightly covering a supporting element (2) in the area of a recess (1). Said system comprises a closing element (3) which can be inserted in the recess (1) and a cover layer (8) covering at least one area of the supporting element (2) surrounding the closing element (3). The closing element (3) is produced from a polyphenylene ether-based plastic material and the cover layer (8) is produced from a polyvinyl chloride-based plastic material. The resulting chemical adhesion of the cover layer (8) to the closing element (3) allows an excellent sealing of the recess (1).

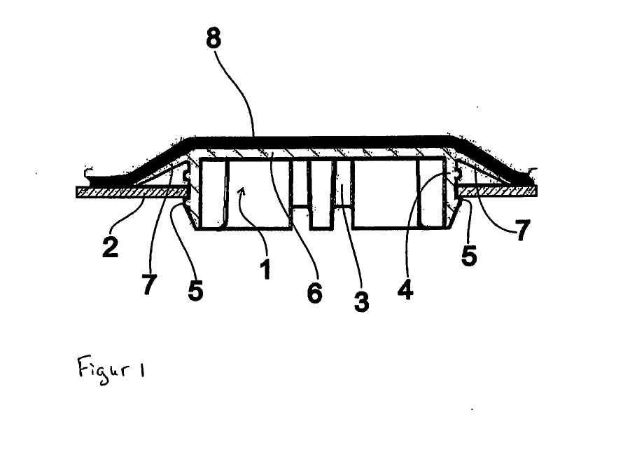

The invention relates to a system for tightly covering a supporting element in the area of a recess.

Conventional systems for tightly covering a metal supporting element in the area of a recess exhibit a metal closing element with a zinc-nickel coating or surface-treated by means of cataphoresis and a cover layer made of a polyvinylchloride-based material.

The invention is based on the problem of suggesting a system of the type described above that is characterized by excellent sealing, with a simple design and simple, inexpensive producibility.

According to the invention, this problem is solved with a system of the type mentioned above having the features indicated in patent claim 1.

In a closing element made from a polyphenylene ether-based material, the cover layer made of a polyvinylchloride-based material adheres very well as a result of chemical adhesion, so that excellent sealing is achieved with a design that is still simple, and simple and inexpensive producibility is achieved based on the lack of any need for a surface treatment of the closing element.

Additional useful further developments of the invention are the objects of the subclaims.

Additional useful forms and advantages emerge from the following description of a preferred embodiment, including references to the single FIGURE of the drawing.

The FIGURE of the drawing shows a cross-section detail of a system according to the invention in the area of a recess 1 in a supporting element 2 that is produced from sheet metal, for example. The system has a closing element 3 that is designed with an insertion segment 4 that can be inserted into the recess 1 and has external dimensions matched to it. Formed on the insertion segment 4 is a locking system 5 that engages with the supporting element 2 in a specific position when the insertion segment 4 is inserted into the recess 1, and fixes the closing element 3 in the recess 1.

In addition, in the embodiment shown the closing element 3 is designed with a flat cover segment 6 that extends between opposite sides of the insertion segment 4, which stands up slightly over the outside of the supporting element 2 after the closing element 3 has been fixed in the recess 1. Formed on the outside of the cover segment 6 is an edge shield 7 which extends laterally beyond the edge of the recess 1, and which rests with slight pretension on the supporting element 2 when the closing element 3 is properly placed in the recess 1.

The closing element 3 is produced from a plastic material that is based on polyphenylene ether (usually abbreviated as “PPE”). Such a plastic material is sold under the name VESTORANφ by Degussa AG High Performance Polymers, Marl, Germany, for example. After the closing element 3 has been produced from the PPE material, no further processing takes place.

In addition, the system according to the illustrated embodiment has a cover layer 8, which, with proper design of the system according to the invention, lies directly on the supporting element 2 and directly against the closing element 3 outer surface that is formed by the outside of the cover segment 6 and the edge shield 7. The cover layer 8 is produced from a plastic material based on polyvinylchloride (usually abbreviated as “PVC”), and is bonded with the PPE material of the closing element 3 and the metal of the supporting element 2 by means of chemical adhesion, so that excellent sealing of the recess 1 is achieved with extremely flat construction.

The cover layer 8 is applied after the cataphoretic pretreatment of the supporting element 2 with the closing element 3 inserted into the recess 1. Heating takes place next, preferably at a temperature that is the same as the cataphoretic pretreatment, whereby as a result of their chemical compatibility, in the areas where they border one another the materials of the closing element 3 and the cover layer 8 mix into a uniform intermediate layer, the cover layer 8 adheres to the exposed areas of the supporting element 2, and a leakproof bond is formed as a result.

In another further development, the supporting element 2 is also produced from a plastic material to which the cover layer 8 made of a PVC material adheres so well that a leakproof covering of the recess 1 is achieved.

1. System for tightly covering a supporting element (2) in the area of a recess (1), having a closing element (3) that can be inserted into the recess (1) and a cover layer (8) that covers the closing element (3) and at least one area of the supporting element (2) that surrounds the closing element (3), whereby the closing element (3) is produced from a polyphenylene ether-based plastic material and the cover layer (8) is produced from polyvinylchloride-based plastic material.

2. System according to claim 1, characterized in that the closing element (3) exhibits a flat cover segment (6).

3. System according to claim 1 characterized in that the closing element (3) exhibits an edge shield (7) that protrudes circumferentially beyond an insertion segment (4) that can be inserted into the recess (1).

4. System according to claim 1, characterized in that the closing element (3) exhibits a locking system (5) for positive engagement with the supporting element (2).

5. System according to claim 2, characterized in that the closing element (3) exhibits an edge shield (7) that protrudes circumferentially beyond an insertion segment (4) that can be inserted into the recess (1).

6. System according to claim 2, characterized in that the closing element (3) exhibits a locking system (5) for positive engagement with the supporting element (2).

7. System according to claim 3, characterized in that the closing element (3) exhibits a locking system (5) for positive engagement with the supporting element (2).
